(19) United States
(12) Patent Application Publication
(10) Pub. No.: US 2021/0217006 A1
(43) Pub. Date: Jul. 15, 2021

(54) Accessing and Providing Distributed Applications

(71) Applicant: Clove Inc, Boston, MA (US)

(72) Inventors: Sivaprakash Ragavan, Boston, MA (US); Sundaresan Vellaichamy, Hyderabad (IN)

(21) Appl. No.: 16/741,036

(22) Filed: Jan. 13, 2020

(51) Int. Cl. G06Q 20/38; H04L 9/32; G06Q 20/36; G06Q 20/34; G06Q 20/32; G06Q 40/02; G06K 19/07; G06K 19/06; G06K 1/12; G06F 3/12

(52) U.S. Cl. CPC G06Q 20/3829; G06Q 10/107; G06Q 20/3678; G06Q 20/3672; G06Q 20/347; G06Q 20/341; G06Q 20/3278; G06Q 20/385; G06Q 40/02; G06K 19/0723; G06K 19/06037; G06K 1/121; G06F 3/1243; G06F 3/1206; G06F 3/1238; G06F 3/1222; H04L 2209/38; H04L 2209/56; G06Q 2220/00; H04L 9/3234

(57) ABSTRACT

A method for generating and providing a two-dimensional code is provided. The two-dimensional code encodes data for loading a client side of a decentralized application in a web browser of a client device. The two-dimensional code also encodes a private key of a blockchain account that has been funded with a predetermined amount of crypto-currency. The method can also include creating the blockchain account. The method can further include funding the blockchain account with the predetermined amount of crypto-currency and refreshing one or more of the two-dimensional code and the blockchain account. Related systems, computer-readable mediums, and articles are also described.

### TECHNICAL FIELD

The subject matter described herein relates to approaches for accessing and providing decentralized applications.

### BACKGROUND

Digital currency environments or networks, such as blockchain feature a distributed ledger or record of transactions. A blockchain includes blocks, each block including a copy of one or more transactions. These blocks are linked together via an unchangeable reference (e.g., a chain). This structure facilitates security within the digital currency environment in that the content stored in the blocks of the blockchain cannot be altered. Various distributed computing platforms that can include multiple distributed nodes can be used to implement applications in a decentralized fashion within the blockchain environment. The decentralized applications, referred to as Dapps, can be stored as blocks on the blockchain, and thus are similarly unchangeable.

Performing a transaction with a Dapp that changes the blockchain (for example, writing data to the blockchain) can require transactions to be paid for by signing a transaction with a private key. A user can fund a blockchain account using real currency that can be converted to crypto-currency which can be usable on or within the blockchain network. This account can include a private key that can be used to sign a transaction that is submitted to the blockchain network and enables the blockchain node that processes the transaction to be paid.

In order to use a Dapp, a user must locate and configured a suitable digital wallet application or program on a computing device configured to exchange data with the blockchain network. The digital wallet program is linked to a funded account prior to using the wallet program with the Dapp. Configuring the digital wallet program can further entail storing any recovery data needed in the event the user loses or forgets their password.

### SUMMARY

In an aspect, a non-transitory computer readable medium stores data characterizing a location of a decentralized application; and a private key of a blockchain account.

One or more of the following features can be included in any feasible combination. For example, the data, when provided to at least one data processor forming part of at least one computing system, can enable the at least one computing system to execute the decentralized application using the location of the decentralized application and the private key, the execution including causing performance of a transaction on a blockchain. The computer readable medium can include a substrate including paper, a sticker, a card, a display and/or an electronic ink display; and the substrate can store the data encoded as printed indicia. The computer readable medium can include a radio frequency identity (RFID) tag, a near field communication (NFC) tag, a memory storing the data in an encoded form, a magnetic strip storing the data, and/or a chip storing the data. The data can be encoded. The data can be encoded in a two-dimensional code. The location of the decentralized application can include a link, a pointer, or a uniform resource locator (URL) to at least a part of the decentralized application. The decentralized application can be stored at least in part on a blockchain.

In another aspect, a method includes providing a two-dimensional code that encodes: data for loading a client side of a decentralized application in a web browser of a client device; and a private key of a blockchain account that has been funded with a predetermined amount of crypto-currency; the providing includes generating the two-dimensional code.

One or more of the following features can be included in any feasible combination. For example, the generating can include printing the two-dimensional code on an object. The printing can include either printing the two-dimensional code directly onto the object or printing the two-dimensional code on a first object that adheres to the object. The object can be a card or a sticker. The decentralized application can be stored at least in part on a blockchain. The decentralized application can be stored at least in part in a distributed file system, where the data for loading a client side of a decentralized application includes a uniform resource locator (URL) for an address of a location in the distributed file system; and/or wherein the decentralized application is at least stored in part on a web server.

The method can include creating the blockchain account; funding the blockchain account with the predetermined amount of crypto-currency; and refreshing one or more of the two-dimensional code and the blockchain account. The refreshing can include providing a new two-dimensional code, and adding crypto-currency to the blockchain account.

In yet another aspect, a method includes accessing a private key for a pre-paid blockchain account; accessing a decentralized application front-end; and providing encoded data that combines the private key and data for accessing the decentralized application front-end with a client device.

One or more of the following features can be included in any feasible combination. The providing can include producing an encoded product. The encoded product is a physical object. The physical object can include a card, a toy, and/or a sticker. The encoded product can include a two-dimensional (QR) code representing the encoded data displayed thereon. The physical object can include a memory storing the encoded data in a readable form. The memory can include a magnetic strip or a chip. The encoded product can include a digital object provided to an end user via an email, a text message, and/or an in-app communication. The method can include accessing a new private key and associating it with the encoded data; and adding funds to the pre-paid blockchain account.

In yet another aspect, an article includes an encoded data element that can be scanned, interrogated, and/or executed to provide, to a client device, a decentralized application front-end and a private key of a pre-paid blockchain account that has been funded with a predetermined amount of crypto-currency.

One or more of the following features can be included in any feasible combination. The encoded data element can include a two-dimensional code on the surface of the product; and/or the encoded data element can include an RFID tag that can be interrogated via an RFID reader. The article can include a display. The encoded data element can store code that is executed to display a two-dimensional code on the display that is configured to be scanned to provide a decentralized application uniform resource locator (URL) and the private key. The display can be updatable to display a new two-dimensional code; and/or the display can be a low power display or an electronic paper (E-ink) display.

In yet another aspect, a method includes storing an association between a decentralized application and private keys for blockchain accounts that have been: funded with a predetermined amount of crypto-currency, and associated with a front-end of the decentralized application; determining transactions signed with the private keys on a blockchain network; and associating data of the transactions with a developer account associated with the decentralized application.

One or more of the following features can be included in any feasible combination. For example, the method can include providing at least part of the transactions data as display data to an end user device associated with the developer account. The method can include providing two-dimensional codes that each include a common uniform resource locator (URL) for a front-end of the decentralized application and a unique private key of a pre-paid blockchain account. The method can include storing associations between the private keys and user identities; and providing at least some of the user identities to an end user device associated with the developer account.

In yet another aspect, an article includes an encoded uniform resource locator (URL) data pointing to a network location where a decentralized application front-end program is stored; and an encoded private key for a pre-funded blockchain account. The decentralized application front-end program includes data for calling a decentralized application back-end program from a blockchain and data for transmitting a transaction data to the blockchain.

One or more of the following features can be included in any feasible combination. A signed transaction data can be signed by using the private key. The private key can be encrypted, and/or the private key can be for single use or for limited uses.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a conventional system for interacting with Dapps;

FIG. 2 is a diagram illustrating an interface for submitting a transaction to a blockchain via a Dapp;

FIG. 3 is a dataflow diagram illustrating a system for interacting with Dapps according to the systems and methods described herein;

FIG. 4 is a diagram illustrating a user interface for submitting a transaction to a blockchain using a pre-paid private key according to the systems and methods described herein;

FIG. 5 is a diagram illustrating a user interface for a transaction receipt received as a result of submitting a transaction to a blockchain using a pre-paid private key according to the systems and methods described herein;

FIG. 6 is a diagram of a develop platform for associating Dapps with a user-access mechanism according to the systems and methods described herein;

FIG. 7 is a flow chart illustrating a method for funding a blockchain account based on a two-dimensional code provided using the system described in relation to FIG. 3;

FIG. 8 is a flow chart illustrating a method of using a private key to fund a blockchain account using the system described in relation to FIG. 3; and

FIG. 9 is a flow chart illustrating a method of associating users and Dapps using the development platform described in relation to FIG. 6.

Like reference symbols in the various drawings indicate like elements.

### DETAILED DESCRIPTION

End-user adoption of Dapps used in blockchain environments can be limited by the end-users's ability to locate and properly configure a Dapp on a client device in order to perform a transaction within the blockchain environment using the client device. Users may employ a search server that lists Dapps of interested to users but searching can be error prone and require specific search inputs to accurately identify the desired Dapp. Further, when a user is able to locate the desired Dapp, the user will need to have a supply of relevant crypto-currency in order to use the Dapp. Also, a web browser configured on the user's client device must be capable of interacting with a blockchain network as any transactions performed on the network must be funded to be processed. Accordingly, a user who has successfully located the desired Dapp may not be able to use it as intended unless the user also has access to a funded account and a browser that is capable of communicating with the blockchain network.

Dapps can be decentralized because they are stored within the blockchain in a decentralized fashion. For example, each node in the blockchain can include a copy of the Dapp. Dapps can be formed in two parts. A front-end that the end user can obtain, such as via a web browser with an extension or via a mobile app. The front-end provides functionality for the client device to interact with a back-end of the Dapp that can be stored on the blockchain. The back-end can contain the logic or executable instructions associated with the operation of the Dapp. Once the end user obtains the Dapp front-end, the back-end can be made accessible and the end user can use the Dapp with his or her account private key. A Dapp developer creates a Dapp and places the back-end on the blockchain, which gives the back-end a specific address and metadata, such as the Dapps application binary interface (ABI), describing how to communicate with back-end. This allows the back-end to be located and used by the Dapp's front-end.

Typically web browsers cannot communicate with the blockchain network unless they are modified. For example, an end user wishing to interact with the blockchain network can be required to install a full node of the blockchain. In addition, the user may be required to use a specialized browser that is configured to communicate with the blockchain network. In some situations, the user can install an extension of the web browser. MetaMask, for example, is a popular web browser extension because it provides a common browser as well as middleware, which allows the browser to communicate with the blockchain network. The web browser extension can also provide digital wallet functions for account management and signing transactions.

Conducting transactions, or otherwise altering the blockchain, requires signing the transaction with a private key. A blockchain account must be funded with real currency, which can be subsequently converted into crypto-currency that is accepted within the blockchain network. The blockchain account includes a private key, which can be used to sign the transaction for submission to the blockchain network. In this way, the particular node of the blockchain network can be paid to process the transaction on behalf of the user. Digital wallet programs can be used to fund blockchain accounts but include additional limitations which can further reduce the adoption and use of Dapps in blockchain environments.

Typically, installing a digital wallet program can be considered an impediment to end user adoption of Dapps. For example, to configure and use a Dapp, the end-user can be required to first locate and install a suitable digital wallet program at a client device. In addition, the user can be required to store an encryption seed phrase provided to the user. The seed phrase can be required to be securely stored by the user in the event that account recovery is necessary, such as when the user has forgotten the account password. Further, the account(s) stored in the digital wallet program needs to be funded. Funding an account can be cumbersome. Fraud prevention practices can require an extended delay before the transactions funding the account have cleared and the account becomes usable. These issues can cause frustration among users and result in low adoption or usage rates for Dapps within a blockchain environment. As a result of the complexity of setting up a digital wallet program, users may avoid using Dapps and would benefit from systems and methods which allow a user to rapidly configure and fund a digital wallet program for use with an easily located Dapp.

Developers of Dapps can also be affected by these user challenges. The adoption issues faced by end users can also discourage Dapp developers from choosing to create and deploy Dapps that are backed by blockchain networks. As a workaround, Dapp developers have considered signing transactions on behalf of users, for example using a back-end process implemented on a server, in order to avoid use of MetaMask or other similar digital wallet programs. This approach of using proxy signatures is generally disfavored because it gives the Dapp access to the user's private key and can require users to trust the Dapp. Further, if implemented on a server, this removes the decentralized nature of the Dapp. In addition, developers have explored providing a funded, private key for the user to accomplish back-end transaction signing. This is generally not considered an economical solution and has not been widely adopted.

To address the foregoing challenges and issues for end users and developers, systems, methods, articles, and computer readable mediums, are described herein to facilitate end-user adoption of Dapps for blockchain environments or networks. As will be described, the subject matter described eliminates and/or avoids certain steps that the end user commonly must take to use blockchain Dapps. An article, such as a quick response (QR) code, a matrix barcode, or a two-dimensional barcode acts as a front-end of a Dapp. For example, in some implementations, a user can scan a QR code to seamlessly access the Dapp on a client device, such as a mobile computing device, and can rapidly and efficiently begin using the Dapp to sign blockchain transactions. An example embodiment can include pre-funding a blockchain account required for submitting signed transactions to the blockchain, obtaining a private key, and providing the private key and an address of a Dapp front-end program via the article. For example, a QR code can be printed, such that when scanned and processed by the client device, the QR code supplies a uniform resource locator (URL) and the private key. Providing a QR code in this manner can remove barriers to identifying and locating the Dapp. In addition, providing a QR code in this manner can reduce barriers associated with using the Dapp, such as installing a digital wallet program to interact with the blockchain network using a typical browser and paying for transactions on the blockchain with a funded account. In some implementations, QR codes can be referred to as DappCodes.

Some implementations of the current subject matter can enable a QR code to be used in conjunction with an unmodified web browser that can load and interact with a Dapp by simply scanning a QR code via a camera or scanner of a client device. The QR code can include a URL to access a Dapp front-end program from a network location, such as a node in a distributed file system. As a result, the front-end program can interact with a Dapp back-end on the blockchain network and can be used to submit a signed transaction to the blockchain network using the private key. The QR code can be read by a QR code reader or scanner of a client device and can cause the client device to load a mobile browser. The mobile browser can access a web application front-end and use the private key to sign transactions. Some example Dapps which can be implemented using some of the implementations of the subject matter described herein can include applications associated with submitting product reviews, pictures, and votes.

Some implementations of the current subject matter provide a development platform that Dapp developers can utilize to assist in gaining user adoption of a Dapp they have created and seek to deploy in a blockchain network or environment. The development platform can associate a Dapp with prepaid accounts and end-user products, such as cards or other user facing objects which can include a QR code or similar representation.

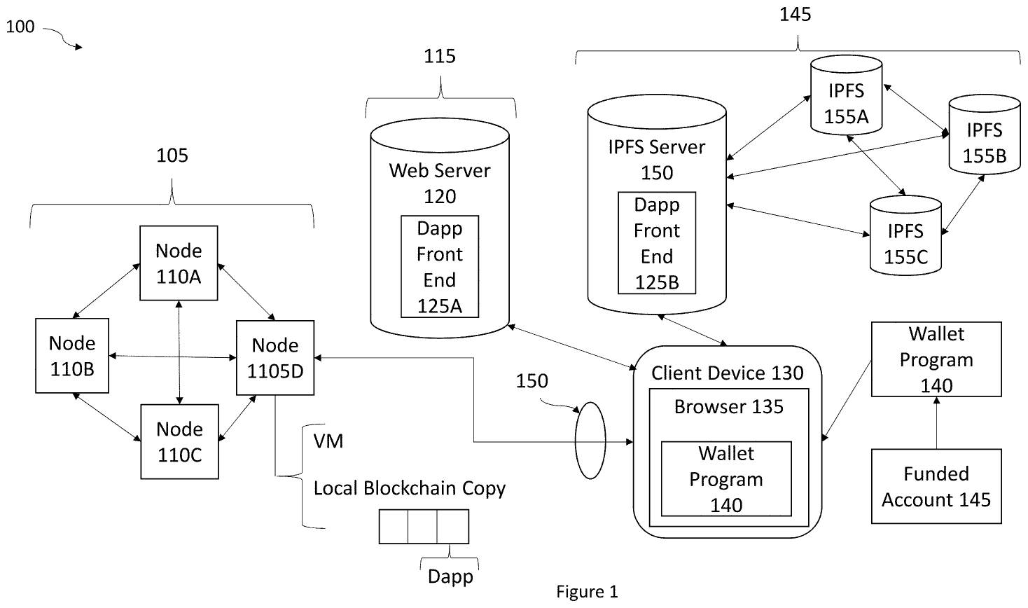

FIG. 1 is a system diagram illustrating an example conventional system 100 for interacting with Dapps. As shown in FIG. 1, the system 100 can include a blockchain network 105, such as an Ethereum network. The network 105 can form a decentralized back-end within a blockchain network and can include nodes 110, such as node 110A, 110B, 110C, and 110D. The nodes 110 participate in the blockchain and each node 110 can include a local copy of the blockchain. Each node can execute blockchain transactions using a virtual machine (VM), such as an Ethereum VM.

A developer can generate a Dapp by coding a Dapp back-end in an appropriate programming language associated with the blockchain network or environment. For example, a developer can program a Dapp using Solidity for Ethereum blockchain networks. The developer can migrate the back-end version of the Dapp onto the blockchain. For example, in some implementations, the Dapp can be written to tabulate votes. The developer can use a program to migrate the back-end of the vote tabulation Dapp to the blockchain for storage. Users can later access the front-end of the Dapp to submit votes to be tallied by the back-end portion of the Dapp.

A Dapp developer can write the Dapp's front-end in a browser friendly language such as hypertext markup language (HTML), cascading style sheets (CSS), JavaScript or the like. The Dapp's front-end 125, such as Dapp front-end 125A, can be stored in a centralized front-end network location 115, such as web server 120. As shown in FIG. 1, the Dapp front-end 125A can be reachable by a browser 135 configured on a client or mobile computing device, such as client device 130. The Dapp front-end 125A can include data such as contract addresses and ABI data to allow browser 135 to locate the Dapp's back-end stored on the blockchain network 105 so that the user can utilize the Dapp.

In some implementations, the Dapp developer may additionally or alternatively provide the Dapp's front-end 125 on a web server or distributed file system 145 such as an InterPlanetary File System (IPFS) as shown in FIG. 1. The distributed file system 145 can include a server, such as IPFS server 150 and server nodes 155, such as server nodes 155A, 155B, and 155C. In some implementations, server nodes 155A, 155B, and 155C form part of a decentralized storage network. The IPFS server 150 can store the Dapp front-end 125B.

As shown in FIG. 1, the client device 130 can include a browser 135 which can be extended to include a digital wallet program 140. In some implementations, the digital wallet program 140 can include MetaMask. The browser 135 can be extended using the MetaMask digital wallet program 140 and can enable user data to be collected by front-end elements for subsequent processing by the blockchain network 105. In the example of a voting Dapp, the front-end elements can include a user interface (UI), which can further include graphical elements such as voting buttons to record votes. The votes can then be communicated to the blockchain network 105. For example, in some implementations, the digital wallet program 140 provides the browser with a Web3 interface 150, which can be configured using a JavaScript Object Notation (JSON) Remote Procedure Call (RPC) for communication with the blockchain network 105. The digital wallet program 140 also allows the user to submit signed or paid transactions to the blockchain network 105 using a funded account 145 of the user.

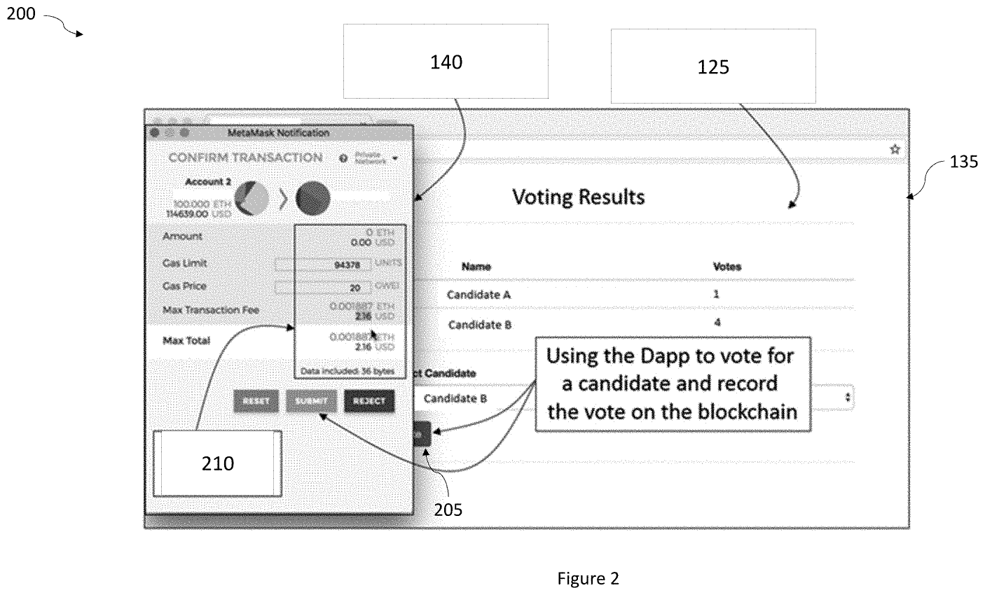

FIG. 2 is a diagram illustrating an example interface 200 for submitting a transaction to a blockchain via a Dapp. As shown in FIG. 2, the browser 135 can be extended to receive and provide the front-end 125 of the exemplary voting Dapp described in relation to FIG. 1. The front-end 125 can include graphical elements 205 associated with collecting votes. The digital wallet program 140 can be configured to submit the transaction, e.g., the collected votes, to the blockchain network 105 and to generate any transaction costs 210 associated with the submission.

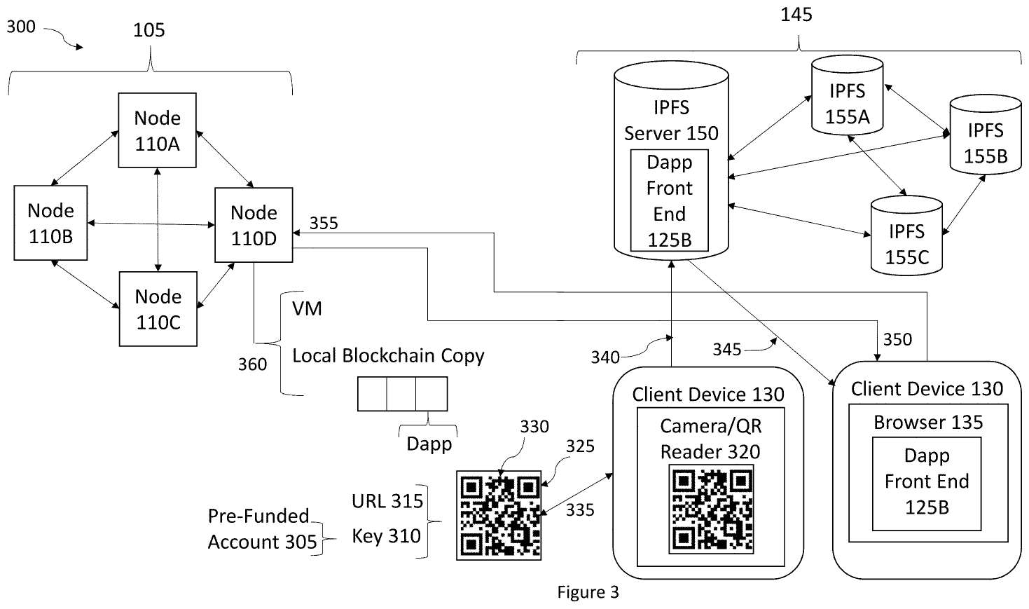

FIG. 3 is a dataflow diagram illustrating an example system 300 for interacting with Dapps according to some implementations of the current subject matter. FIG. 3 includes similar components performing similar functionality as FIG. 1 except where noted otherwise. The system 300 can provide a convenient mechanism for users to locate and use Dapps without searching and without adhering to cumbersome cryptocurrency account funding procedures or complicated installation and maintenance of digital wallet programs.

In some implementations, the system 300 can remove the need for a funded account by providing a pre-funded account 305 and providing its private key 310 in an article or product 325. The article or product 325 can include the private key 310 and the URL 315 encoded into a QR code 330, for example. In this way, the article or product 325 can provide a direct link for the browser 135 to access a front-end 125B Dapp via a URL 315 associated with the QR code 330 which may be included in or be the article or product 325. In some implementations, the QR code 330 and/or a product or article 325 including the QR code 330 can provide all the functionality needed to interact with the blockchain network 105 such as the blockchain communication interface 150 and transaction signing mechanisms offered via wallet programs 140.

In some implementations, the article or card 325 can be a business card or an easily distributable physical item, which can be provided to a potential user of the Dapp. In some implementations, the product or article 325 can be a computer-readable medium including a substrate, such as paper, a sticker, a card, a display, and/or an electronic ink display. In some implementations, the substrate can store the data encoded as printed indicia. In some implementations, the computer-readable medium can include a radio frequency identity (RFID) tag, a near field communication (NFC) tag, a memory storing the data in an encoded form, a magnetic strip storing the data, and/or a chip storing the data. In some implementations, the data is encoded. In some implementations, the data is encoded in a two-dimensional code.

The article or product 325 acts as a Dapp front-end. The card 325 allows a user to access a Dapp directly via scanning or otherwise electronically obtaining a QR code 330 which can be printed on the card 325. The QR code 330 can include encoded data that permits use of the Dapp's front-end program in an unmodified browser for direct interaction with the Dapp. The Dapp's front-end program may be provided as a web application stored at a location coded into the QR code 330 and automatically loaded into the browser 135 in response to scanning the QR code 330 via a QR code reader 320 which can be configured on the client device 130. The Dapp's front-end program includes the data necessary to communicate with the blockchain network 105 and communicate with the Dapp back-end. The QR encoded data 330 further includes a private key 310, which is derived from a pre-funded account 305 prepared by provider of the card 325 ahead of time. The private key 310 can be used by the Dapp to sign transactions on behalf of the user. The QR code 330 therefore includes all of the data needed for the user to directly and easily access and use the Dapp with an unmodified web browser 135, including submitting signed transactions to the blockchain network 105.

As shown in FIG. 3, the system 300 can provide easy access to a useable Dapp via a product 325 including a QR code 330. In the following discussion of FIG. 3, the system 300 will be discussed in the context of an example use case associated with submitting a review of a meeting or event. A business owner or other party of interested associated with the meeting or event may distribute an article or product 325 including a QR code 330 to collect feedback and review comments about the meeting or event. The system 300 will be discussed in operation of a user seeking to submit their review of the meeting or event.

In FIG. 3, a user can obtain 335 the QR code 330 (e.g., via a physical card 325 that can include the QR code 330). The end user might obtain 335 the QR code 330 from a business meeting as a printed card distributed by meeting organizers, or the QR code 330 may be included in a brochure associated with the meeting or event. In some implementations, the QR code 330 can be obtained via materials which may be have been received as a result of an online purchase, or the QR code 330 can be associated with a product or machine in a supply chain management use case for example. The QR code 330 encodes a URL 315 and private key 310. The URL 315 points to the network location where the Dapp's front-end program 125B is stored, for example the IPFS Server 150 or the web server 120 shown in FIG. 1 when a centralized front-end design is configured. In some implementations, the location of the Dapp includes a link, a pointer, or a URL to at least a part of the Dapp. In some implementations, the Dapp can be stored at least in part on a blockchain. The private key 310 is for an pre-funded account associated with the blockchain network 105 and has been configured by the provider of the card 330 ahead of time. Thus, a non-transitory computer readable storage medium can store data obtained via the QR code 330 and the stored data can characterize a location of a Dapp 125 and a private key 310 of a blockchain account. When the stored data is provided to at least one data processor forming part of at least one computing system, the at least one computing system can execute the Dapp 125 using the location of the Dapp and the private key 310. The execution can cause performance of a transaction on a blockchain. In this way, a user is not required to create and store an account 305 via a digital wallet program 140.

A user can access the Dapp by scanning 335 the card 325 QR code 330 with a camera or QR code reader 320. The QR code reader 320 can decode the QR code 330 and can obtain the URL 315. The URL 315 can be transmitted 340 by the client device 130 to the IPFS server 150 storing the Dapp front-end 125B to locate the Dapp's front-end program 125B. The URL 315 includes the key 310. For example, the private key 310 can be appended to or included with the URL 315 such that the key 310 is readily accessible to or identifiable by the browser-based Dapp program 125B.

The browser 135 uses the URL 315 to receive 345 the Dapp front-end program 125B, which includes all of the necessary data for locating and communicating with the blockchain network 105.

In some implementations, the Dapp's front-end program 125 can include functionality for the browser 135 to communicate with the blockchain network 105; a UI, which can be provided via the browser 135, for interacting with the Dapp; and functionality for signing a transaction on the end user's behalf using the private key 310 and submitting the signed transaction to the blockchain within the blockchain network 105. Data for the Dapp's front-end program 125B can be provided by the QR code 330 data (e.g., via the URL 315), by a remote site (e.g., by IPFS node 155), or a combination of the foregoing. In some implementations, the Dapp front-end program 125B can be an HTML application that contains logic and data necessary for making a connection with the blockchain, for example using a Web3.js library configured in the browser 135 of the client device 130. In some implementations, the Dapp front-end HTML application can call the Dapp's back-end from the blockchain using the Dapp back-end's address and can render user interface elements in a display of the browser 135. In some implementations, the Dapp front-end HTML application can collect user input as transaction data to be stored on the blockchain, and can submit transaction data signed by the user to the blockchain using the private key 310.

The client device 130 can access and receive or call 350 data from the Dapp's back-end stored in the blockchain network 105. The client device 130 can then transmit or write 355 transaction data, such as meeting or event reviews, to the blockchain. The system 300 can remove the need for the end user to download any supporting programs or data for communicating with the blockchain network 105. For example, the system 300 can enable the user to submit signed blockchain transactions without installing any browser extensions, Web3 libraries, digital wallet programs, or the like.

Payment from a pre-funded account 305 is required by the blockchain network 105 in order to successfully write 355 the transaction data to the blockchain. The transaction data sent by the user is signed using the private key 310 of the pre-funded account 305, which allows payment for processing the transaction on the blockchain. As describe earlier, the key 310 is provided via the QR code 330 of the card 325 and is appended to the URL 315 loaded into the browser 135. It may be possible to secure the key 310 via encryption; however, in some implementations, the key 310 provided via card 325 can be linked to a pre-funded account 305 that has a low funding value. In this way, concerns of transmitting the key 310 data in the clear can be reduced. In some implementations, the key 310 can be a single use private key or can be a limited use private key.

As shown in FIG. 3, the key-signed transaction is written 355 to the blockchain as a result of the browser 135 transmitting the user's transaction data, such as meeting or event review content, satisfaction ratings, feedback, or votes, as a signed transaction using the key 310 supplied by the QR code 330. The transaction data is written to the blockchain via a write command to node 110 within the blockchain network 105, which can be configured to process the key 310 signed transaction data to add 360 it to the blockchain using the VM. A decentralized program like a smart contract can be configured to execute for such transactions. The VM can execute the smart contract before the transaction is accepted by the Blockchain node. The system 300 described in relation to FIG. 3, can remove the need for a digital wallet program to request confirmation of the transaction prior to submission because the private key 310 is funded by the pre-funded account (and the party associated with the Dapp so that end user need not worry about funding the account in a digital wallet used for their blockchain transaction). The node 110 handling the transaction, for example node 110D as shown in FIG. 3, adds 360 the transaction data to the blockchain. The Dapp can supply the user with a notification indicating the blockchain has been successfully updated in response to receiving a transaction receipt, as shown in FIG. 5.

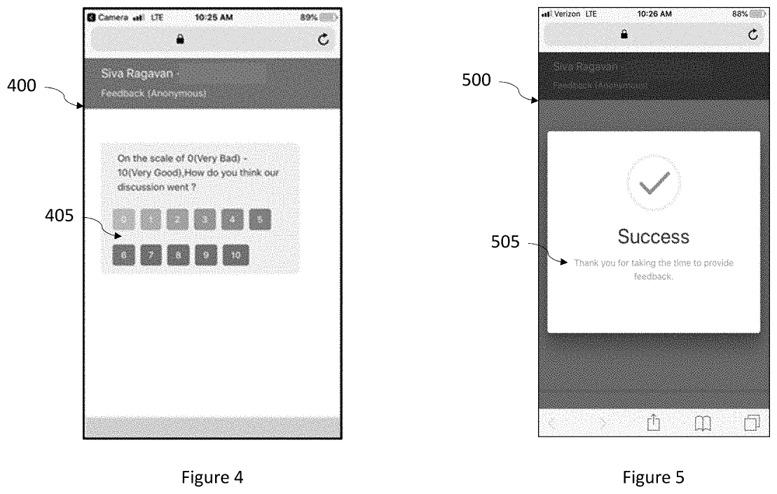

FIG. 4 is a diagram illustrating a user interface 400 for receiving user data 405 to be submitted in a transaction to a blockchain using a pre-paid private key 310 according to the systems and methods described herein. As shown in FIG. 4, the UI 400 is configured to receive user feedback 405 about a discussion.

The Dapp can be configured to collect and process a variety of interactions or transactions which are supported by Dapps of the blockchain network 105 being used. For example, in some implementations, the Dapps can be configured to process customer review feedback, product satisfaction feedback or survey data, gaming transactions, photo uploading, and voting or “liking” a comment, on-line posting, or photo in social networking applications or social media. Other implementations are possible.

FIG. 5 is a diagram illustrating a user interface 500 for a transaction receipt 505 received as a result of successfully submitting a transaction to a blockchain using a pre-paid private key 310 according to some example implementations of the current subject matter.

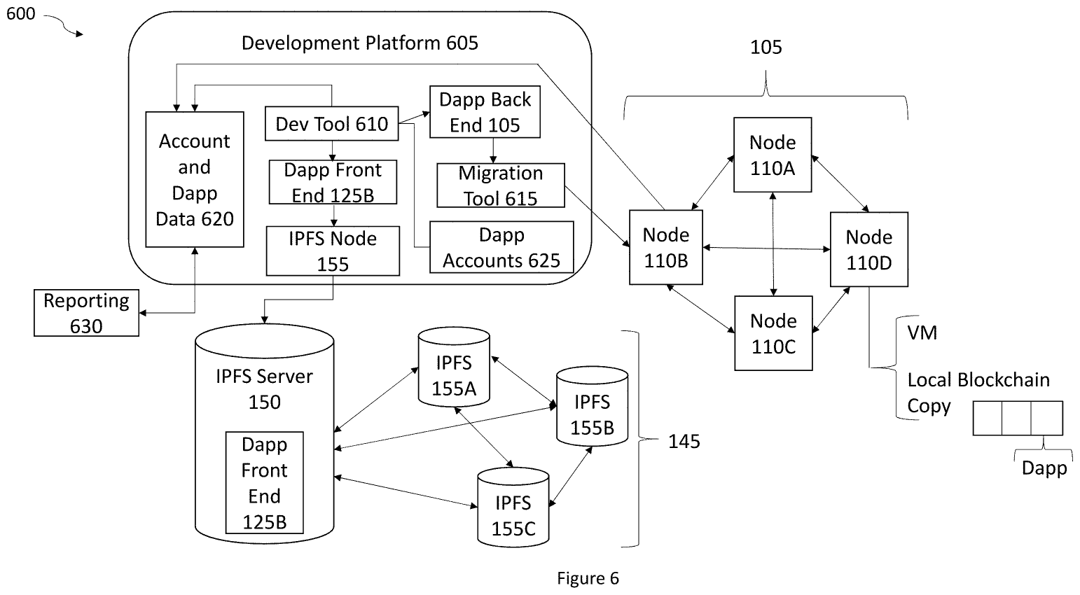

FIG. 6 is a diagram of an example system 600 including a development platform 605 for associating Dapps with a user-access mechanisms according to the systems and methods described herein. FIG. 6 includes similar components performing similar functionality as FIG. 3 except where noted otherwise. The system 600 and the development platform 605 provide a convenient mechanism for Dapp developers to connect with interested end users in a more direct and seamless manner. The development platform 605 permits Dapps to be associated with a Dapp front-end user-access mechanism, e.g., QR code, which can supply a link to the Dapp and to the pre-funded account.

The development platform 605 can be provided as a service and can include a development tool 610 made available to Dapp developers. The development tool 610 can enable Dapp developers to code the back-end and/or the front-end of the Dapp. The development platform 605 can include a migration tool 615 for migrating the Dapp to the blockchain network 105 and publishing the Dapp to the IPFS Server 150 via an IPFS node 155 configured within the development platform 605. The development platform 605 can also include account and Dapp data 620, which may be associated with one or more pre-funded Dapp blockchain accounts 625. In this way, a Dapp developer can specify that for a particular Dapp, a predetermined number of pre-funded accounts should be associated with the Dapp. This allows the Dapp developer to create the Dapp and also to plan for easy end user access.

The development platform 605 can enable the business owners, parties of interest associated with the Dapp, and/or Dapp developers to access the URL location for obtaining the Dapp via a browser 130. In this way, the QR codes can be generated containing the URL 315. The development platform 605 can also enable access to the private keys 310 of pre-funded accounts 305 that can be used to access and interact with the Dapp. Therefore, the development platform 605 provides the business owners, parties of interest associated with the Dapp, and/or Dapp developers with tools to collect the necessary information for producing the articles or objects that are provided to end users to access and interact with the Dapp, such as business cards 325 that can include the printed QR code 330. The development platform 605 can also provide the business owners, parties of interest associated with the Dapp, and/or Dapp developers with controls for generating data associated with read metrics from the blockchain which correspond to particular Dapp accounts 625.

The Dapp accounts 625 created using the development platform 605 allow association of pre-funded accounts with implemented Dapps whether or not the Dapps were developed using the development platform 605. In operation, an article or product 325 can be created using the Dapp account 625 and can be distributed to the end users. The Dapp account 625 can be funded with a predetermined amount of currency, for example, an amount that is sufficient to allow the end user to perform a specific transaction such as submission of a meeting or event review via the Dapp using the blockchain network 105. The amount of currency provided may be low, as the provision of the private key 310 via the card 325 permits anyone in possession of the card 325 to use it.

The details of the funded account 625 such as the private key 310 and funding amount can be stored in association with the Dapp in the account and Dapp data 620 within the development platform 605. In this way, the association of the account with the specific Dapp can be stored and when the Dapp is used, the usage can be billed back to the Dapp developer by the business owners or parties of interest managing the development platform 605. This allows the business owners or parties of interest managing the development platform 605 to sell pre-funded blockchain accounts to Dapp developers for use with the Dapps and distributed products 325 having the QR codes 330. Using QR codes 330 which are provided via physical products 325 enables the business owners or parties of interest managing the development platform 605 to monetize the benefits provided by system and methods described herein via sales of the physical products 325 to Dapp developers or end users directly.

The development platform 605 can enable the Dapp developer to identify a transaction using the private key 310 that was used to sign the transaction. The development platform 605 can allow Dapp developers to identify transactions based on an account or a user, if the account data is associated with a user identity. This can be accomplished, for example, by associating a user ID with a private key 310 generated previously, such as a prior to distribution of the QR code 330.

In some implementations, the development platform 605 can be configured to allow Dapp developers to create Dapps and have them linked to a QR code for easy distribution and adoption by users. The business owners or parties of interest associated with the Dapp can utilize the development platform 605 to facilitate pre-payment of blockchain transactions and ease of discovery of the Dapp via the QR codes or the QR code bearing products or article. In this way, the business owners or parties of interest associated with the Dapp can recoup transaction-based fees, such as a fee to be paid per instance of QR code usage.

Within the development platform 605, the transaction data added to the blockchain network by the end users can be freely available because the data is public and reads from blockchain network do not require a transaction fee to be paid. The development platform 605 can be configured to output reporting data 630 providing summaries, tables, and data related to Dapp usage trends such as Dapp reads, writes, as well as metrics about transaction submissions. For example, for a meeting or event review Dapp, the business owners or parties of interest associated with the Dapp can view data regarding how users are rating the meeting or event. Such reporting data 630 can be provided via a mobile interface on a client device. In some implementations, the reporting data 630 can be generate from the account and Dapp data 620.

As the accounts used to generate the blockchain transactions are inherently anonymous, the private key data may be pre-processed to associate the key data with a user identity in order to make the reporting data 630 more useful in certain contexts. The business owners or parties of interest associated with the Dapp can utilize this functionality to learn more about the end user, their purchase, or the meeting or event which was associated with the QR code and the private key signed transaction. This reporting data 630 can be useful in providing customer or product support, supply chain auditing, or user and product/event characterization. For example, linking a user ID to a transaction can be useful in determining the user associated with a QR code scanned at a particular point in a meeting, voting process, supply chain, social media task or transaction, or online sale.

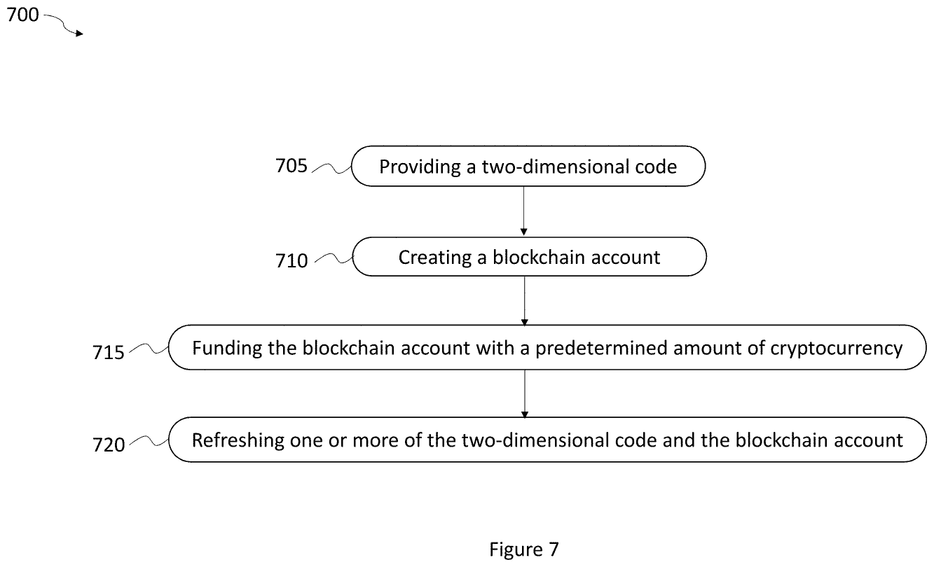

FIG. 7 is a flow chart illustrating an example method for funding a blockchain account based on a two-dimensional code provided using the system described in relation to FIG. 3. In operation 705, the system 300 can generate and provide a two-dimensional code, such as a QR code 330. In some implementations, the two-dimensional code can be provided on or within an article or product 325 such as a business card, a toy, or a sticker. The two-dimensional code can encode data for loading a client side of a decentralized application in a web browser of a client device. The two-dimensional code can also encode a private key of a blockchain account that has been funded with a predetermined amount of crypto-currency. In some implementations, the two-dimensional code is provided as encoded data that is include in a digital object provided an end user in an email, a text message, or via an in-application communication or notification.

In operation 710, the system 300 creates a blockchain account. The blockchain account can be created to fund transactions submitted through a Dapp to the blockchain network. The two-dimensional code can encode private key data associated with the blockchain account.

In operation 715, the blockchain account is funded with a predetermined amount of cryptocurrency. In order for a blockchain transaction to be processed via the blockchain network 105, the transaction must be funded to cover the costs of processing the transaction. In order to avoid the complexities of setting up and linking a digital wallet program to a Dapp, a predetermined amount of cryptocurrency can be added to the blockchain account to that a Dapp user can immediately begin submitting transactions for processing.

In operation 720, the blockchain account and/or the two-dimensional code can be refreshed. The blockchain account can be refreshed to add additional predetermined amounts of cryptocurrency. The two-dimensional code can also be refreshed so that the new code is generated for a new or different event, task, or transaction for which the Dapp is associated. In this way, Dapp usage can be more accurately determined by associating users and their corresponding blockchain accounts to unique two-dimensional codes, in which a first two-dimensional code differs from a second two-dimensional code.

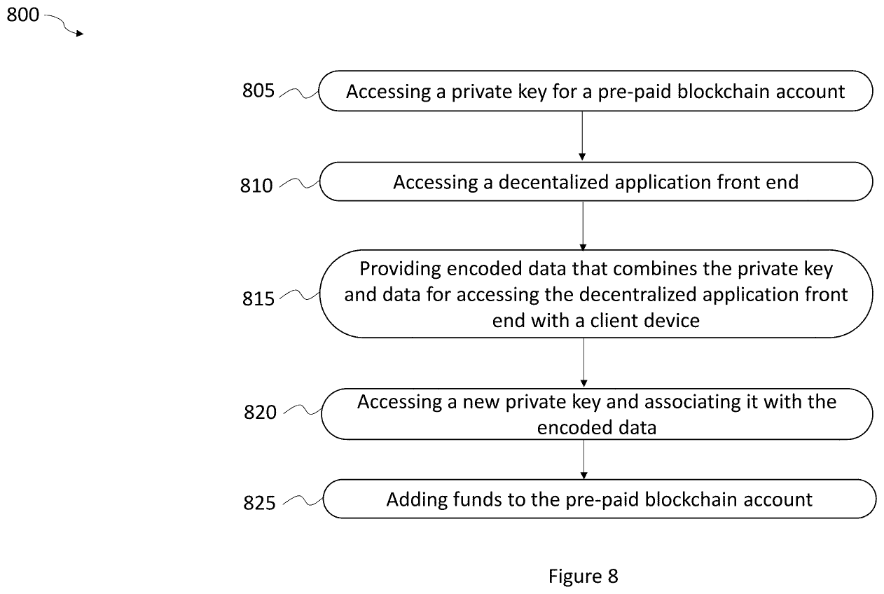

FIG. 8 is a flow chart illustrating an example method of using a private key to fund a blockchain account using the system described in relation to FIG. 3.

In operation 805, a private key for a pre-paid blockchain account can be accessed by a client device 130 via a web browser 135 configured on the client device 130. The private key can be provided via a QR code 330 provided within or on an article or product 325 that the user has received in relation to a Dapp the user wishes to utilize for a particular blockchain transaction.

In operation 810, a decentralized application front-end can be accessed. For example, using the QR code 330 encoding the private key 310 associated with a pre-funded blockchain account, a user can access a Dapp front-end 125. The QR code 330 also includes a URL 315 identifying the location of the Dapp front-end 125.

In operation 815, encoded data is provided that combines the private key 310 and the URL 315 identifying the location of the Dapp front-end. The encoded data can be provided by the client device 130 to the user within the browser 135 and can enable the user to provide data to be processed in a signed blockchain transaction via the blockchain network 105.

In operation 820, a new private key 310 can be accessed and the new private key can be associated with the encoded data. The new private key 310 can be associated with a new blockchain account and can be further used by the Dapp to submit signed blockchain transactions using the new blockchain account associated with the new private key 310.

In operation 825, funds can be added to the pre-paid blockchain account.

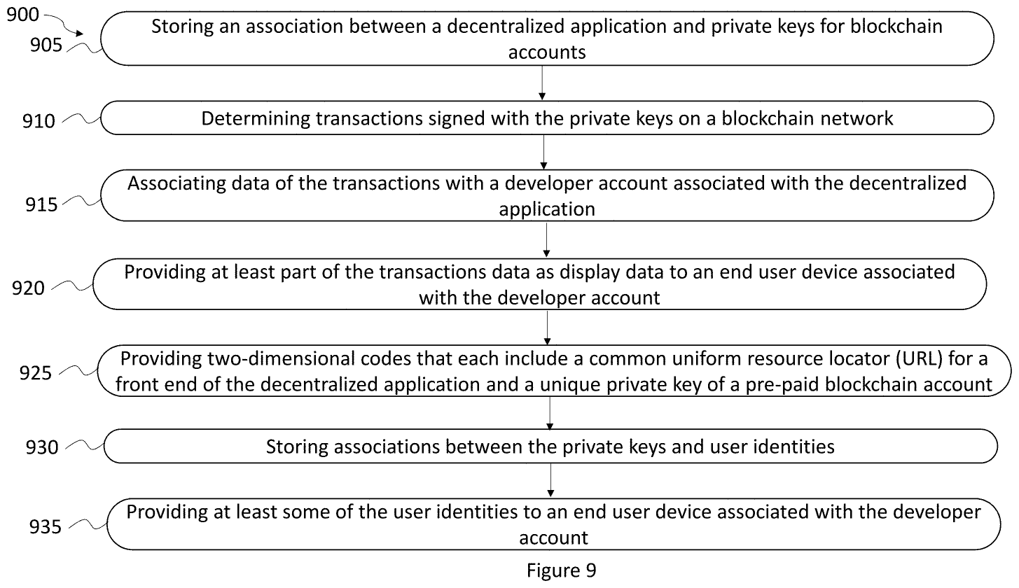

FIG. 9 is a flow chart illustrating an example method of associating users and Dapps using the development platform 605 described in relation to FIG. 6. In operation 905, the development platform 605 can determine and store associations linking a Dapp with the private keys corresponding to the blockchain accounts from which a user wishes to use to fund the signed blockchain transaction submitted to the blockchain network 105. The associations can be stored within the account and Dapp data 620, which can include a database, or similar data structure providing a mapping or association between a Dapp and one or more private keys 310.

In operation 910, the development platform 605 can determine transactions that have been signed with the private keys on a blockchain network. For example, the development tool 610 can access transaction data from the Dapp back-end 105 and account data the Dapp accounts 625 in order to determine which transactions have been signed using the private keys 310 associated with a particular Dapp account.

In operation 915, the development platform 605 can associate the signed transactions submitted to the blockchain network 105 via the Dapp using the private key 310 provided in the QR code 330 with a specific Dapp developer account. In this way, the development platform 605 enables a developer to track and manage Dapp usage.

In operation 920, the development platform 605 can provide at least part of the transactions data as display data to an end user device associated with the developer account. In this way, a Dapp developer can visualize the transaction data on the client device to gain insight regarding Dapp installation, configuration, and usage.

In operation 925, the development platform 605 provides two-dimensional codes that each include a common URL for a front-end of the Dapp and a unique private key of a pre-paid blockchain account.

In operation 930, the development platform 605 stores associations between the private keys 310 and the user identities. Using the Dapp account data 625 and the Account and Dapp data 620, the development platform 605 can create and store an association linking the private keys associated with a user's pre-funded blockchain account and the users identity.

In operation 935, the developer platform 605 provides at least some of the user identities to an end user device associated with the developer account. In this way, the developer platform 605 enables a Dapp developer to visualize and gain insight from the identities of Dapp users. The Dapp developer can determine trends in the transaction data for certain users and can assess how different classes or categories of users utilize the Dapp to submit their blockchain transactions. In some implementations, the user identities can be used to assess how different Dapp accounts are funded and the rates at which depleted funding in Dapp accounts is replenished.

Although some variations have been described in detail above, other modifications or additions are possible. For example, other uses for Dapps can include smart contracts, crypto-currency exchanges, gaming transactions, and interactions or transactions for social applications. Any transaction type can require a funded account to use the blockchain network 105. Some implementations, of the subject matter described herein can provide a pre-funded private key via a product or article, which can act as a front-end (or part thereof) for any kind of Dapp, rather than the exact functionality of one particular Dapp.

Some implementations of the current subject matter described herein can allow end users of a Dapp to find and access the Dapp in a direct way. A variety of data formats and configurations can be used to provide the data used to access the Dapp, the mechanism used to distribute the data necessary for end users to access the Dapp, and the mechanism to allow end users to use the Dapp to communicate with the blockchain and sign transactions with a private key. For example, the product or article that can be used to distribute the access data, such as the URL and private key, can be modified to suit many different use cases. In some implementations, an electronic QR code can be distributed via email or via SMS/text messaging. In some implementations, the Dapp front-end can take a variety of forms, so long as it allows any native web browser or client-side program to access and use the Dapp. For example, the end user's browser may indirectly communicate with the blockchain via a server back-end, which can be configured to sign transactions. In some implementations, the encoded product or article may include more data or alternative data besides the URL and private key for a Dapp front-end. For example, the Dapp front-end logic can be coded into the product for direct execution without use of a web application and URL.

In some implementations, the current subject matter can enable an approach to offer an incentive to entice someone take an action, make a transaction or use a product and/or Dapp. A product or article can be used in personal settings or at common places like events. It can allow early adopters of Blockchain to bring another individual into the Blockchain ecosystem with just 1-scan, thereby increasing utilization of the Blockchain ecosystem.

Some implementations of codes described herein can be of any type of machine-readable medium, including, but not limited to, a barcode, a QR code, two-dimensional bar code, a prescribed font, optical character recognition (OCR) characters, Radio Frequency Identification (RFID) data, Near-Field Communication (NFC) data, Bluetooth data, alphanumeric characters, non-alphanumeric characters, symbols, facial recognition data, and the like.

In some implementations, the product or article including the QR code can be refreshed to provide a different QR code. For example, a display screen can provide a refreshed or alternate QR code using electronic paper or ink. In some implementations, additional funds may be added to the pre-funded account associated with the QR code using the Dapp back-end of the system described herein. In some implementations, the Dapp back-end can provide the additional funds after a predetermined period of time, after a predetermined number of previous successful transactions, after a predetermined event, or the like.

The subject matter described herein provides many technical advantages. For example, some implementations of the current subject matter can enable a QR code, a QR code reader and an unmodified web browser to provide convenient and direct access to a Dapp. The QR code can include a private key of a pre-funded or prepaid account that permits use of the Dapp for submitting signed transactions to a blockchain without requiring configuration of a separately digital wallet program to obtain, fund, and use a funded account for submitting the blockchain transactions. Additionally, the development platform can enable Dapps to be easily associated with a convenient front-end user-access mechanism, such as a QR code, which can supply a link to the Dapp and to the pre-funded account.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A non-transitory computer readable medium storing data characterizing:
a location of a decentralized application; and
a private key of a blockchain account.

2. The computer readable medium of claim 1, wherein the data, when provided to at least one data processor forming part of at least one computing system, enables the at least one computing system to execute the decentralized application using the location of the decentralized application and the private key, the execution including causing performance of a transaction on a blockchain.

3. The computer readable medium of claim 1, wherein the computer readable medium includes a substrate including paper, a sticker, a card, a display and/or an electronic ink display; and
wherein the substrate stores the data encoded as printed indicia.

4. The computer readable medium of claim 1, wherein the computer readable medium includes an radio frequency identity (RFID) tag, a near field communication (NFC) tag, a memory storing the data in an encoded form, a magnetic strip storing the data, and/or a chip storing the data.

5. The computer readable medium of claim 1, wherein the data is encoded.

6. The computer readable medium of claim 1, wherein the data is encoded in a two-dimensional code.

7. The computer readable medium of claim 1, wherein the location of the decentralized application includes a link, a pointer, or a uniform resource locator (URL) to at least a part of the decentralized application.

8. The computer readable medium of claim 1, wherein the decentralized application is stored at least in part on a blockchain.

9. A method comprising:
providing a two-dimensional code that encodes:
data for loading a client side of a decentralized application in a web browser of a client device; and
a private key of a blockchain account that has been funded with a predetermined amount of crypto-currency; wherein the providing includes generating the two-dimensional code.

10. The method of claim 9, wherein the generating includes printing the two-dimensional code on an object, wherein the printing includes either printing the two-dimensional code directly onto the object or printing the two-dimensional code on a first object that adheres to the object.

11. The method of claim 10, wherein the object is a card or a sticker.

12. The method of claim 9, wherein the decentralized application is stored at least in part on a blockchain, wherein the decentralized application is stored at least in part in a distributed file system, where the data for loading a client side of a decentralized application includes a uniform resource locator (URL) for an address of a location in the distributed file system; and/or wherein the decentralized application is at least stored in part on a web server.

13. The method of claim 9, further comprising:
creating the blockchain account;
funding the blockchain account with the predetermined amount of crypto-currency; and
refreshing one or more of the two-dimensional code and the blockchain account;
wherein the refreshing includes providing a new two-dimensional code, and adding crypto-currency to the blockchain account.

14. A method comprising:
accessing a private key for a pre-paid blockchain account;
accessing a decentralized application front-end; and
providing encoded data that combines the private key and data for accessing the decentralized application front-end with a client device.

15. The method of claim 14, wherein the providing includes producing an encoded product, wherein the encoded product is a physical object.

16. The method of claim 15, wherein the physical object is a card, a toy, and/or a sticker.

17. The method of claim 15, wherein the encoded product includes a two-dimensional (QR) code representing the encoded data displayed thereon.

18. The method of claim 15, wherein the physical object includes a memory storing the encoded data in a readable form, wherein the memory is a magnetic strip or a chip.

19. The method of claim 15, wherein the encoded product is a digital object provided to an end user via an email, a text message, and/or an in-app communication.

20. The method of claim 14, further comprising:
accessing a new private key and associating it with the encoded data; and
adding funds to the pre-paid blockchain account.

21. An article comprising:
an encoded data element that can be scanned, interrogated, and/or executed to provide, to a client device, a decentralized application front-end and a private key of a pre-paid blockchain account that has been funded with a predetermined amount of crypto-currency.

22. The article of claim 21, wherein the encoded data element is a two-dimensional code on the surface of the product; and/or wherein the encoded data element is an RFID tag that can be interrogated via an RFID reader.

23. The article of claim 21, further comprising a display, wherein the encoded data element stores code that is executed to display a two-dimensional code on the display that can be scanned to provide a decentralized application uniform resource locator (URL) and the private key; wherein the display is updatable to display a new two-dimensional code; and/or wherein the display is a low power display or an electronic paper (E-ink) display.

24. A method comprising:
storing an association between a decentralized application and private keys for blockchain accounts that have been:
funded with a predetermined amount of crypto-currency, and
associated with a front-end of the decentralized application;
determining transactions signed with the private keys on a blockchain network; and
associating data of the transactions with a developer account associated with the decentralized application.

25. The method of claim 24, further comprising:
providing at least part of the transactions data as display data to an end user device associated with the developer account.

26. The method of claim 24, further comprising:
providing two-dimensional codes that each include a common uniform resource locator (URL) for a front-end of the decentralized application and a unique private key of a pre-paid blockchain account.

27. The method of claim 24, further comprising:
storing associations between the private keys and user identities;
providing at least some of the user identities to an end user device associated with the developer account.

28. An article comprising:
an encoded uniform resource locator (URL) data pointing to a network location where a decentralized application front-end program is stored; and
an encoded private key for a pre-funded blockchain account;
wherein the decentralized application front-end program includes data for calling a decentralized application back-end program from a blockchain and data for transmitting a transaction data to the blockchain.

29. The article of claim 28, wherein a signed transaction data is signed by using the private key.

30. The article of claim 28, wherein the private key is encrypted, and/or the private key is for single use or for limited uses.
